(19) United States
(12) Patent Application Publication
(10) Pub. No.: US 2006/0123205 A1
(43) Pub. Date: Jun. 8, 2006

(54) Control data storage apparatus and process

(75) Inventor: Mamoru Ogura, Gunma (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/295,579

(22) Filed: Dec. 7, 2005

(30) Foreign Application Priority Data
Dec. 8, 2004 (JP) 2004-355632

(51) Int. Cl. G06F 13/00

(52) U.S. Cl. 711/154

(57) ABSTRACT

Control data storage apparatus includes a memory section including a plurality of control data memory blocks to store control data. There is further provided a control section to determine a selected memory block to store control data by selecting from the control data memory blocks.

### BACKGROUND OF THE INVENTION

The present invention relates to apparatus and/or process for storing control data such as adjusting values for an electronic control device.

U.S. Pat. No. 6,598,114 B2 (US 2002/0029313A1≈JP 2002-82841A≈EP 1187143 A2) shows a data storage apparatus including a memory section having one block including a series of memory regions, and a control section which reads data from the last memory region (most recently updated memory region) among the written memory regions in which data are already written. When new data is to be written, all the new data is written into a leading memory region among the unwritten (blank or writable) memory regions. When there remain no unwritten memory regions, an indicator indicates a message that the update is disabled.

### SUMMARY OF THE INVENTION

In the above-mentioned data storage apparatus, the number of control data update operations is limited by the number of memory regions in the single memory block. Therefore, this control data storage apparatus is not necessarily adequate for storing control data which must be updated frequently. Moreover, in order to obtain blank memory regions, it is necessary to erase all the data in the block since the block is so arranged that the block must be erased as a whole at a time, and data cannot be erased partly. It is possible to store frequently updated control data in an external storage device. In this case, however, the cost is increased by the external device.

It is therefore an object of the present invention to provide control data storage apparatus and/or process for increasing the number of data updating operations, and for storing and updating control data effectively.

According to one aspect of the present invention, a control data storage apparatus comprises: a memory section including a plurality of control data memory blocks to store control data; and a control section configured to determine a selected memory block to store control data by selecting from the control data memory blocks.

According to another aspect of the invention, a control data storage apparatus for a vehicle, comprises: a memory section including a plurality of control data memory blocks to store control data sets for control for the vehicle; and a control section configured to write a new control data set into a selected one of the control data memory blocks of the memory section to update control data, to perform the control for the vehicle, by reading a control data set written most recently in one of the control data memory blocks, and to clear one of the control data memory blocks.

According to still another aspect of the present invention, a control data storage process, comprises: determining a selected memory block to store control data by selecting one from a plurality of control data memory blocks in a memory section; and storing control data in the selected memory block.

### BRIEF DESCRIPTION OF THE DRAWINGS

FIG. 1 is a block diagram showing an electronic control system or apparatus according to one embodiment of the present invention.

FIG. 2 is a view illustrating the internal structure of a flash memory (registered trademark) in the electronic control system of FIG. 1.

FIG. 3 is a flowchart showing a reading/writing control process performed by the control system of FIG. 1.

FIG. 4 is a view illustrating the internal structure of the flash memory (registered trademark) in a predetermined full state.

### DETAILED DESCRIPTION OF THE INVENTION

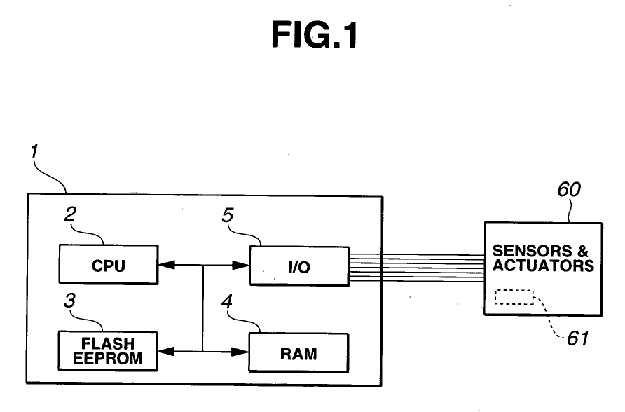

FIG. 1 shows, in a block diagram, control data storage apparatus in the form of electronic control apparatus 1 according to one embodiment of the present invention. Electronic control apparatus 1 according to this embodiment is adapted to be installed in a vehicle. Electronic control apparatus 1 includes, as main components, a central processing unit CPU 2 for controlling operations of the entire control system; a flash memory (Flash Electronically Erasable and Programmable Read Only Memory; Registered trademark) 3 for storing information such as a control program, and control data; a RAM (Random Access Memory) 4 for serving as a working area for CPU 2 in controlling the electronic control apparatus; and an input/output interface (I/O) 5 for handling the transfer of signals to and from an external section 60 including external devices such as various sensors and actuators mounted on the vehicle. In this example shown in FIG. 1, the external section 60 includes a vehicle key switch (or vehicle main switch) 61.

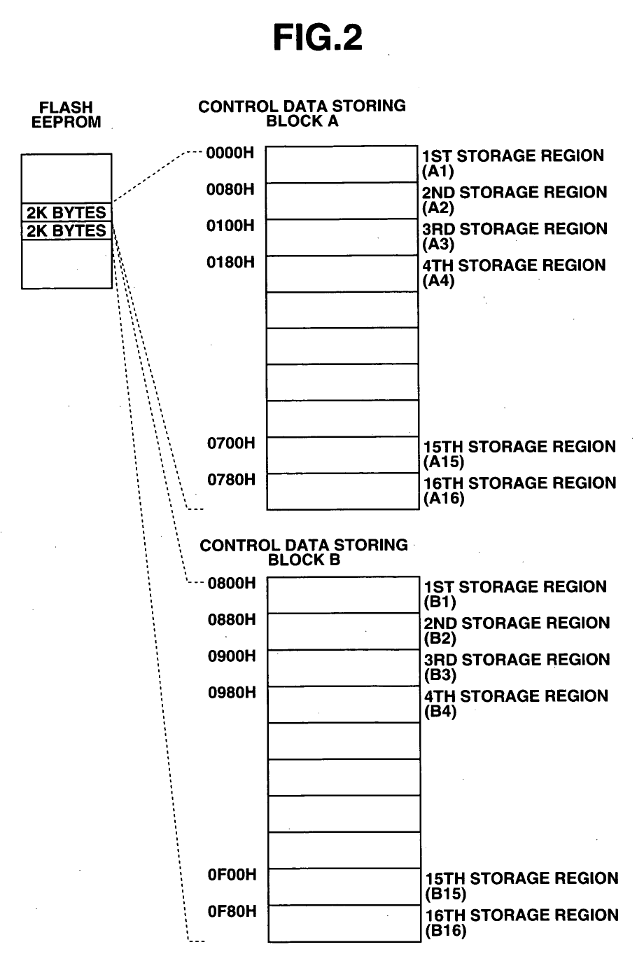

The flash memory 3 of this example contains two control data storing memory blocks A and B of 2 kilobytes for storing control data, as shown in FIG. 2. Each memory block A or B contains a plurality of control data storage memory regions A1˜A16 or B1˜B16 each of which has a capacity for storing all the control data of one set. In the thus-constructed electronic control apparatus, CPU 2 performs reading and writing control operations as mentioned below, and increases the number of possible repetitions of data update significantly, so that it becomes possible to use the flash member as a memory for storing control data requiring frequent update and requiring a great number of update operations.

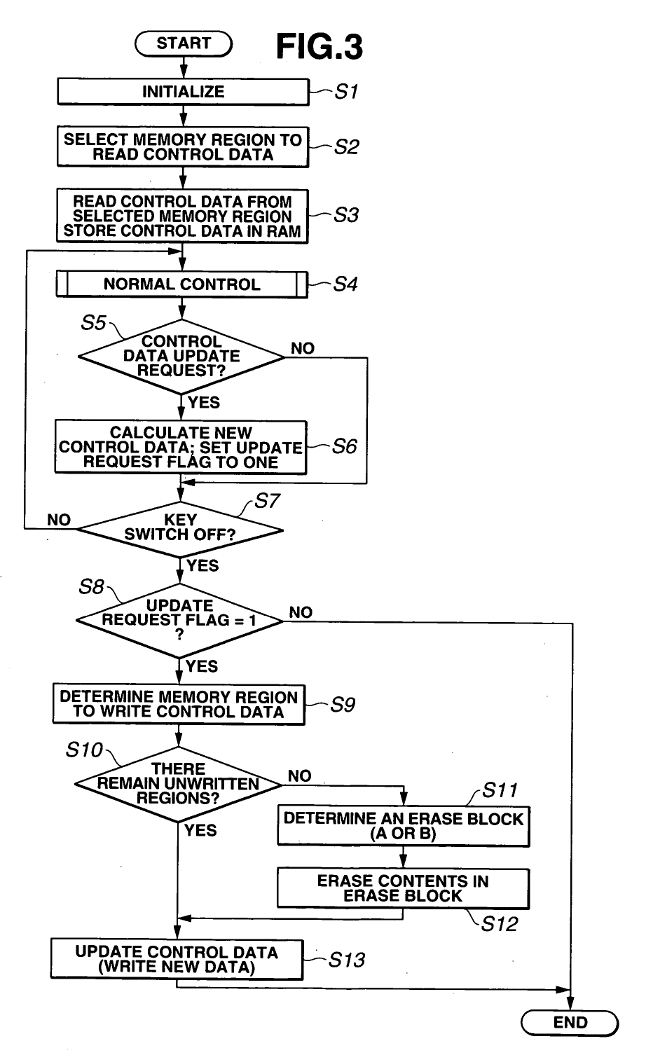

FIG. 3 shows a reading and writing control process according to the embodiment, performed by CPU 2. The control process of FIG. 3 is started when an ignition key of the vehicle is turned on.

At a first step S1, CPU 2 initializes RAM 4 and registers (not shown). After S1, CPU 2 proceeds to a next step S2. At S2, CPU 2 selects, as a control data readout region, the memory region in which control data is written most recently among the written memory regions in which control data is already written. Then, at a step S3 following S2, CPU 2 reads the most recent control data from the control data readout region determined at S2, and stores the control data in RAM 4. At a step S4, CPU 2 performs a normal control such as a fuel injection control and an automatic transmission shift control for the vehicle, by using the control data stored in RAM 4.

At a step S5, CPU 2 examines whether there is a control data update request for updating control data with new control data such as learning data or information on malfunction. When there is no control data update request, CPU 2 proceeds from S5 directly to a step S7. When there is a control data update request, CPU 2 proceeds to a step S6. At S6, CPU 2 prepares new control data by calculation, and sets an update request flag to one (on state) to indicate the existence of a control data update request.

At step S7, CPU 2 examines whether the ignition key 61 of the vehicle is in an off state or not. When the ignition key 61 is not in the off state, then the CPU 2 returns from S7 to S4. When the ignition key is in the off state, then the CPU 2 proceeds from S7 to a next step S8, At S8, CPU 2 examines whether the update request flag is equal to one or not. When the update request flag is not equal to one, then the CPU 2 terminates the process of FIG. 3. When the update request flag is equal to one, then the CPU 2 proceeds from S8 to a next step S9.

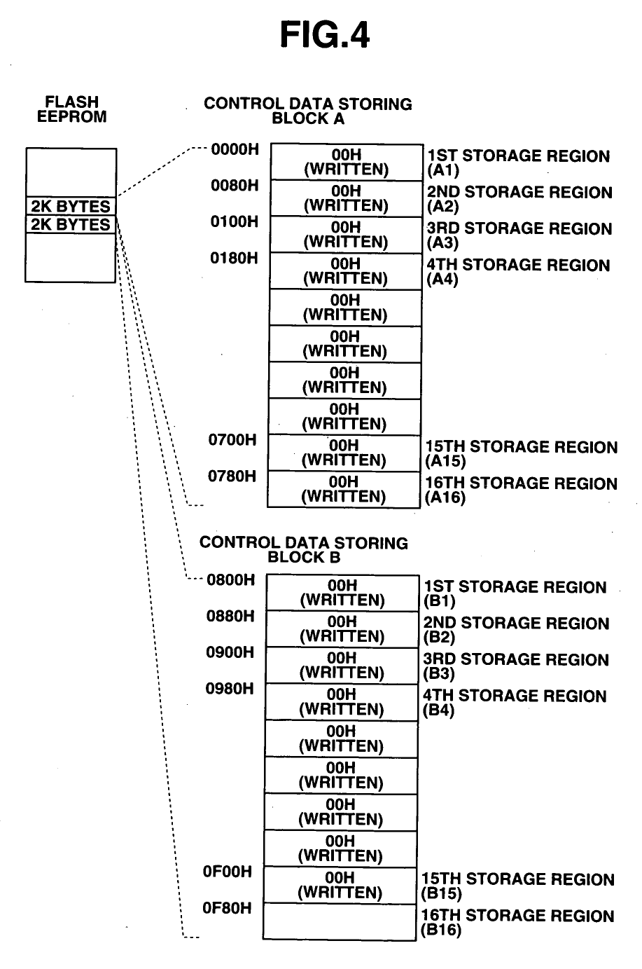

At step S9, CPU 2 determines a memory region into which the control data calculated at S6 is written. Then, CPU 2 checks if the memory blocks are in a predetermined full state or not by examining whether there remains a writable memory region in which the control data calculated at S6 can be stored. In this example, CPU 2 judges that the control data memory blocks are in the full state when there remains only one writable (or blank) memory region as shown in FIG. 4; and CPU 2 judges that the memory blocks are not in the full state when there remains two or more writable memory regions. In this way, CPU 2 determines, at a step S10, whether the memory blocks are in a non-full state having writable memory regions. In this example, CPU 2 judges that the control data memory blocks are in the non-full state when there remains two or more writable memory regions. When there remains only one writable memory region, then the answer of S10 is NO (corresponding to a block erase request signal). From S10, CPU 2 proceeds to a step S13 if the memory blocks are in the non-full state, and to a step S11 if the memory blocks are not in the non-full state.

At step S11, CPU 2 determines an erase block which is a selected one of the memory blocks and which is full so that control data are written in all the memory regions and there remains no writable region. Then, at a step S12, CPU 2 erases the control data in the selected erase block determined at S11. After S12, CPU proceeds to S13.

At step S13, CPU 2 stores the new control data in the writable memory region determined at S9 in one of the memory blocks. After S13, CPU 2 terminates the control process of FIG. 3.

In the thus-constructed electronic control apparatus according to the embodiment of the present invention, the memory section such as a flash memory (registered trademark) is arranged to have two or more control data memory blocks (A, B), and the CPU 2 (serving as a main component of a control section) is arranged to select, as a memory location in which new control data is stored, one of the control memory blocks. Therefore, the control apparatus can increase the number of control data writable memory regions, and thereby increase the number of repetition of update operation of control data. Therefore, the memory section can be used as a memory for storing control data which requires frequent updating. The electronic control system according to the embodiment can eliminate the need for additionally providing a costly EEPROM, and thereby reduce the cost.

In the electronic control apparatus according to the embodiment of the present invention, the memory section includes at least first and second memory blocks, as the control data memory blocks to store control data; and the control section is configured to check control data writable memory regions in the control data memory blocks, and to write control data into a control data writable memory region in the other of the first and second memory blocks if one of the first and second memory blocks is full so that there remains no control data writable region in which control data can be written. Therefore, it is possible to increase the number of possible repetition of data updating.

When there remain few or no control data writable memory regions in the control data memory blocks, the control section ascertains a last updated memory block in which control data is written most recently, and erases control data in a selected erase block which is one of the control data memory blocks other than the last updated memory block. Therefore, if control data is lost, during the erasing operation, because of power supply shutoff etc., the control apparatus can use control data in the other memory block and restore the control data.

In the illustrated embodiment, step S13 corresponds means for storing control data sets sequentially in control data memory blocks in a memory to update control data; step S4 corresponds to means for reading a most recent control data set from one of the control data memory blocks; step S10 corresponds to means for examining whether the memory blocks are in a predetermined state; and at least one of steps S11 and S12 corresponds to means for clearing one of the control data memory blocks when the memory blocks are in the predetermined state.

This application is based on a prior Japanese Patent Application No. 2004-355632 filed on Dec. 8, 2004. The entire contents of this Japanese Patent Application No. 2004-355632 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A control data storage apparatus comprising:
a memory section including a plurality of control data memory blocks to store control data; and
a control section configured to determine a selected memory block to store control data by selecting from the control data memory blocks.

2. The control data storage apparatus as claimed in claim 1, wherein the memory section includes first and second memory blocks, as the control data memory blocks to store control data; and the control section is configured to check if there remain control data writable memory regions in the control data memory blocks, and to write control data into a control data writable memory region in the other of the first and second memory blocks if one of the first and second memory blocks is full so that there remains no control data writable region in which control data can be written.

3. The control data storage apparatus as claimed in claim 2, wherein the control section is configured to examine if the control data memory blocks are in a predetermined full state, and the control section is further configured to examine which block is a last updated memory block in which control data is written most recently, and to erase control data in one of the control data memory blocks other than the last updated memory block if the control data memory blocks are in the full state.

4. The control data storage apparatus as claimed in claim 3, wherein the control section is configured to judge that the control data memory blocks are in the full state when there remains only one control data writable memory region in the control data memory blocks.

5. The control data storage apparatus as claimed in claim 2, wherein the control section is configured to examine a condition of a key switch, and allow a writing operation to the memory section when the key switch is in an off state.

6. The control data storage apparatus as claimed in claim 1, wherein the memory section includes a flash memory which includes the control data memory blocks.

7. The control data storage apparatus as claimed in claim 1, wherein the control data storage apparatus is a vehicle electronic control apparatus adapted to be mounted on a vehicle; the memory section includes the control data memory blocks to store control data to be used for control in the vehicle; and the control section is configured to perform a control operation to control the vehicle by using the control data in the control data memory blocks.

8. The control data storage apparatus as claimed in claim 7, wherein the control section is configured to perform the control operation when a key switch of the vehicle is in an on state, and to update contents in the control data memory blocks when the key switch is in an off state.

9. The control data storage apparatus as claimed in claim 7, wherein the control section is configured to select, as a selected erase block, one of the memory blocks which is full so that there remains no control data writable memory region, and to erase contents of the selected erase bock.

10. The control data storage apparatus as claimed in claim 9, wherein the control section is configured to examine whether the memory blocks are in a predetermined full state, and to erase all contents in the selected erase block if the memory blocks are in the predetermined full state.

11. A control data storage apparatus for a vehicle, comprising:
a memory section including a plurality of control data memory blocks to store control data sets for control for the vehicle; and
a control section configured
to write a new control data set into a selected one of the control data memory blocks of the memory section to update control data,
to perform the control for the vehicle, by reading a control data set written most recently in one of the control data memory blocks, and
to clear one of the control data memory blocks.

12. The control data storage apparatus as claimed in claim 11, wherein the control section is configured to determine a selected erase block when the control data memory blocks are in a predetermined full state, the selected erase block being one of the control data memory blocks which is full so that there remains no control data writable memory regions in the selected erase block, and which does not contain a most recent control data set which is most recent at the time of judgment that the data memory blocks are in the predetermined full state; and to erase all contents of the selected erase block.

13. A control data storage process, comprising:
determining a selected memory block to store control data by selecting one from a plurality of control data memory blocks in a memory section; and
storing control data in the selected memory block.

14. The control data storage process as claimed in claim 13, wherein the control data storage process further comprises:
checking the number of control data writable regions remaining in the control data memory blocks to produce a block erase request signal when the number of control data writable regions is smaller than a predetermined number;
determining a selected erase block in response to the block erase request signal, the selected erase block being one of the control data memory blocks which is full so that there remains no control data writable memory regions in the selected erase block, and which does not contain most recent control data which is most recent at the time of generation of the block erase request signal; and
erasing all contents of the selected erase block in response to the block erase request signal.

15. A control data storage apparatus comprising:
means for storing control data sets sequentially in control data memory blocks in a memory to update control data;
means for reading a most recent control data set from one of the control data memory blocks in the memory to perform a control operation;
means for examining whether the memory blocks are in a predetermined state; and
means for clearing one of the control data memory blocks when the memory blocks are in the predetermined state.

16. The control data storage apparatus as claimed in claim 15, wherein said examining means includes means for checking the number of control data writable regions remaining in the control data memory blocks to produce a block erase request signal when the number of control data writable regions is smaller than a predetermined number; and said clearing means includes means for determining a selected erase block in response to the block erase request signal, and means for erasing all the control data sets in the selected erase block in response to the block erase request signal, the selected erase block being one of the control data memory blocks which is full so that there remains no control data writable memory regions in the selected erase block, and which is not a last updated memory block containing a most recent control data set.
